(19) United States
(12) Patent Application Publication
(10) Pub. No.: US 2018/0184499 A1
(43) Pub. Date: Jun. 28, 2018

(54) PHOTOELECTRIC MODULE, MOTION SENSING DEVICE AND DRIVING METHOD THEREOF

(71) Applicants: LITE-ON ELECTRONICS (GUANGZHOU) LIMITED, GUANGZHOU (CN); Lite-On Technology Corporation, Taipei (TW)

(72) Inventor: Chuan-Feng Wu, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/697,465

(22) Filed: Sep. 7, 2017

Related U.S. Application Data
(60) Provisional application No. 62/439,155, filed on Dec. 27, 2016.

(30) Foreign Application Priority Data
May 15, 2017 (CN) 201710340773.8

(51) Int. Cl. H05B 33/08; H05B 37/02; G08B 5/36; G01V 8/20; G01J 1/42

(52) U.S. Cl. CPC H05B 33/0872; H05B 37/0281; H05B 37/0218; G01J 1/4228; G01V 8/20; G01J 1/4204; G08B 5/36

(57) ABSTRACT

A motion sensing device configured to detect a movement of an object to generate a detection result is provided. The motion sensing device includes a first light sensor, a photoelectric module and a processor. The first light sensor receives ambient light and generates a first electrical signal. The photoelectric module includes at least one light source and a second light sensor. The second light sensor is disposed beside the at least one light source. The processor generates the detection result according to the first electrical signal, and drives the at least one light source to emit light according to the detection result. The processor drives the second light sensor to receive the ambient light, generates a second electrical signal, and adjusts the detection result according to the second electrical signal. When the at least one light source emits the light, the second light sensor doesn't receive the ambient light. Besides, a photoelectric module and a driving method of the motion sensing device are also provided.

### CROSS-REFERENCE TO RELATED APPLICATION

This application claims the priority benefits of U.S. provisional application Ser. No. 62/439,155, filed on Dec. 27, 2016 and China application serial no. 201710340773.8, filed on May 15, 2017. The entirety of each of the above-mentioned patent applications is hereby incorporated by reference herein and made a part of this specification.

### BACKGROUND

### Field of the Invention

The invention is directed to a sensing device and a driving method thereof. More particularly, the invention is directed to a photoelectric module, a motion sensing device and a driving method thereof.

### Description of Related Art

In a general type motion sensing device, light sensors are disposed to sense a movement of an object or a human. The light sensors include, for example, a sensor type configured for sensing by utilizing a pyroelectric effect as well as a sensor type configured for sensing by utilizing a pyroelectric effect. A passive infrared (IR) sensor may receive IR light irradiated by an object in an environment under detection and sense the movement of the object according to ambient temperature changes. For instance, when a human (or any other organism, e.g., a dog, a cat, etc.) enters a sensing range, a body temperature change thereof causes intensity variation of the IR light, and thus, the IR sensor can sense the movement of the organism.

In the motion sensing device, the IR sensor may also be operated together with other light sensors to commonly sense the ambient light. For example, the IR sensor may generally be operated together with a light sensor capable of receiving visible light, and the light sensor may be configured to compensate or correct the detection result obtained by the IR sensor detecting the ambient light. Alternatively, the light sensor may detect intensity of the ambient light, thereby, when determining that a human or another organism enters the sensing range, determining whether to enable or regulate a related electrical appliance under control, for example, turn on a lamp or a speaker, or regulate brightness of the lamp or a volume of the speaker. Additionally, the motion sensing device, when being operated together with the light source, may also notify the external of its sensing or operation state, such that the external may obtain its sensing or operation state. In order to prevent interference or misjudgment caused by the light emitted by the light source being received by the light sensor capable of receiving the visible light, generally, the light sensor and the light source are respectively disposed in different lens structures to avoid mutual interference. By disposing optical paths isolated from each other, the misjudgment of the light sensor toward the ambient light due to the interference from the light emitted by the light source can be prevented. However, in this way, the motion sensing device needs a plurality of lens structures respectively in line with the light sensor and the light source, and the appearance of the motion sensing device has to be provided with a plurality of holes corresponding to the lens structures, which is unfavorable for appearance compactness and size miniaturization of the motion sensing device.

### SUMMARY

The invention provides a motion sensing device whose light sources and light sensors are driven in a time sharing manner to avoid optical interference.

The invention provides a photoelectric module whose light sources and light sensors are driven in a time sharing manner to avoid optical interference.

The invention provides a driving method of a motion sensing device whose light sources and light sensors are driven in a time sharing manner to avoid optical interference.

An embodiment of the invention provides a motion sensing device configured to detect a movement of an object to generate a detection result. The motion sensing device includes a first light sensor, a photoelectric module and a processor. The first light sensor is configured to receive ambient light to generate a first electrical signal. The photoelectric module includes at least one light source and a second light sensor. The second light sensor is disposed beside the at least one light source. The processor is electrically connected with the first light sensor, the at least one light source and the second light sensor. The processor is configured to generate the detection result according to the first electrical signal. The processor is configured to drive the at least one light source to emit at least one light according to the detection result, drive the second light sensor to receive the ambient light to generate a second electrical signal and adjust the detection result according to the second electrical signal. The second light sensor does not receive the ambient light when the at least one light source emits the at least one light.

An embodiment of the invention provides a photoelectric module adapted to be disposed in a motion sensing device. The motion sensing device is configured to detect a movement of an object to generate a detection result and has a processor configured to adjust the detection result. The photoelectric module includes at least one light source and a light sensor. The light sensor is disposed beside the at least one light source. The processor is electrically connected with the at least one light source and the light sensor. The processor is configured to drive the least one light source to emit at least one light according to the detection result, drive the light sensor to receive ambient light to generate an electrical signal and adjust the detection result according to the electrical signal. The light sensor does not receive the ambient light when the at least one light source emits the at least one light.

An embodiment of the invention provides a driving method of motion sensing device. The motion sensing device is configured to detect a movement of an object to generate a detection result. The driving method of the motion sensing device includes: driving a first light sensor to receive ambient light to generate a first electrical signal and to generate the detection result according to the first electrical signal; driving the at least one light source to emit at least one light according to the detection result; and driving a second light sensor to receive the ambient light to generate a second electrical signal and to adjust the detection result according to the second electrical signal. The light sensor does not receive the ambient light when the at least one light source emits the at least one light.

To sum up, in the motion sensing device, the photoelectric module and the driving method of the motion sensing device according to the embodiments of the invention, the processor is configured to drive the light source to emit the light according to the detection result, drive the light sensor to receive the ambient light to generate the corresponding electrical signal and adjust the detection result according to the electrical signal. In addition, when the light source emits the light, the light sensor does not receive the ambient light. Thus, the light source and the light sensor are driven in a time sharing manner to avoid optical interference. The light source and the light sensor can be designed to share the same lens for light transmission, such that the motion sensing device, with the use of the reduced number of lenses, can have a smaller volume, less material cost and less assembly cost. Moreover, the motion sensing device having simplified assembly components can contribute to compactness of the appearance design.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram illustrating an appearance of a motion sensing device according to an embodiment of the invention.

FIG. 1B is a schematic diagram illustrating an internal structure of the motion sensing device of the embodiment depicted in FIG. 1A.

FIG. 2 is a schematic structure diagram illustrating the photoelectric module of the embodiment depicted in FIG. 1A.

FIG. 3 is a schematic diagram illustrating connection relation among a part of components of the motion sensing device of the embodiment depicted in FIG. 1A.

FIG. 4 is a schematic diagram of the processor of the embodiment depicted in FIG. 1A driving the at least one light source and the second light sensor in timing sequence.

FIG. 5 is a flowchart illustrating a driving method of a motion sensing device according to an embodiment of the invention.

### DESCRIPTION OF EMBODIMENTS

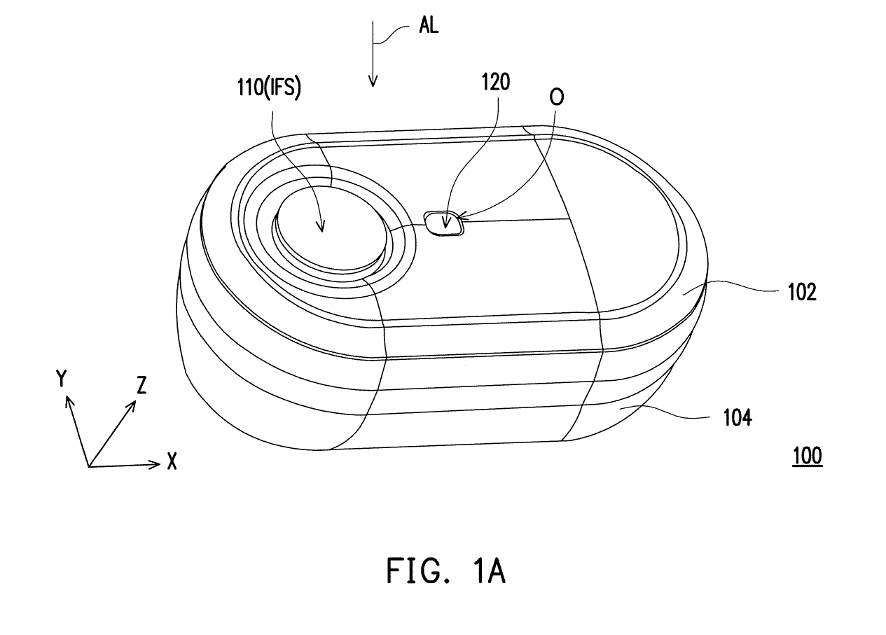

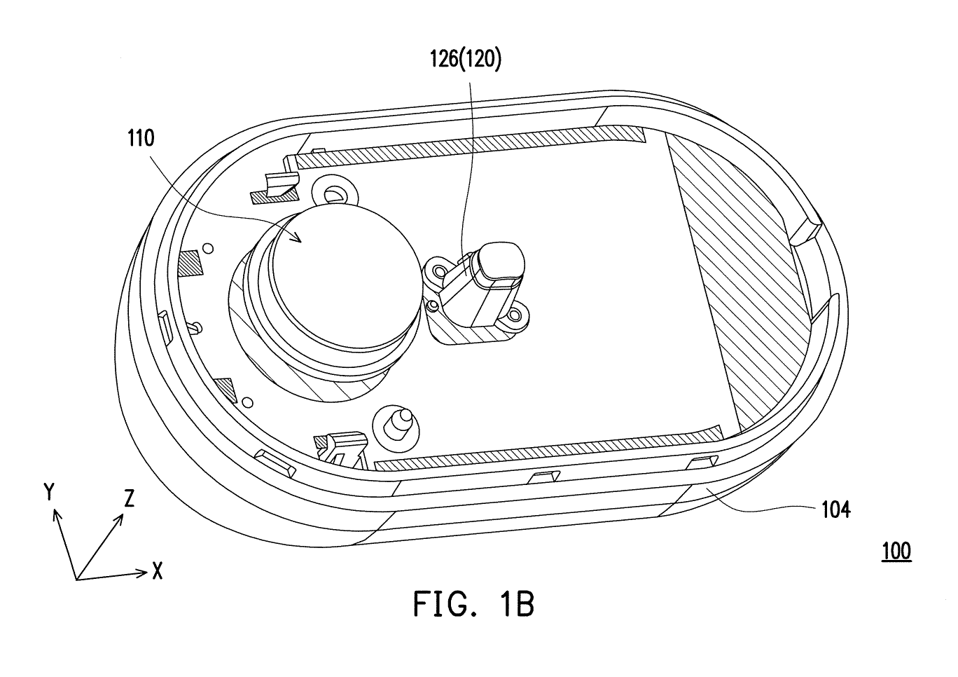

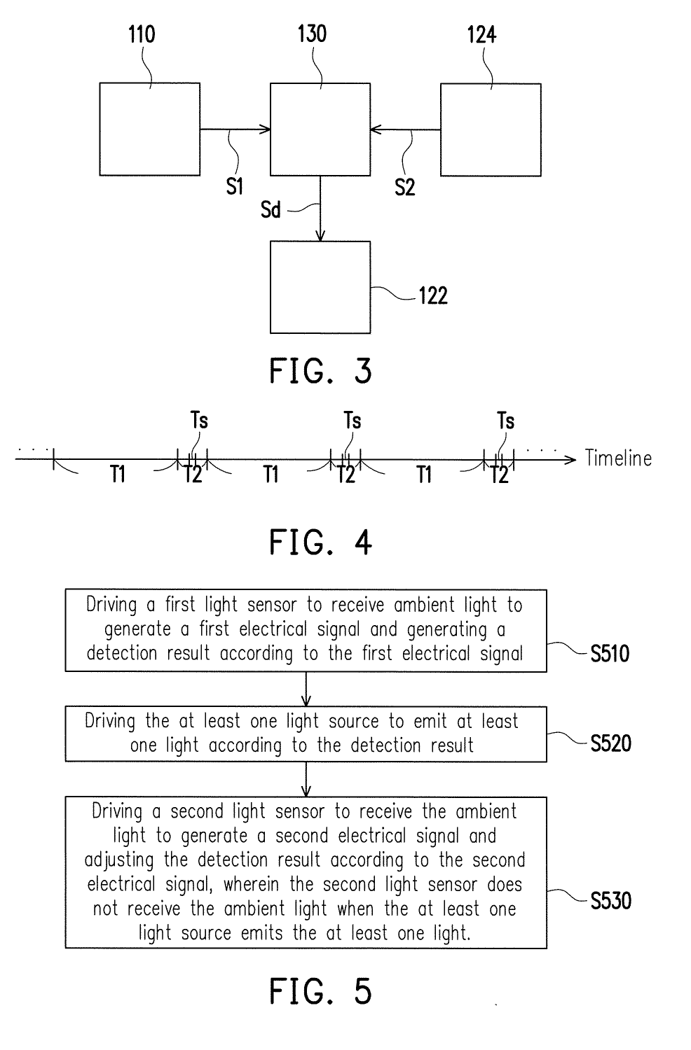

FIG. 1A is a diagram illustrating an appearance of a motion sensing device according to an embodiment of the invention, and FIG. 1B is a schematic diagram illustrating an internal structure of the motion sensing device of the embodiment depicted in FIG. 1A. Referring to FIG. 1A and FIG. 1B, in the present embodiment, a motion sensing device 100 includes a first light sensor 110, a photoelectric module 120, a processor 130 (which is not shown in FIG. 1A and FIG. 1B, and please refer to FIG. 3 for the processor 130), a housing 102 and a housing 104. The first light sensor 110, the photoelectric module 120 and the processor 130 are covered by the housing 102 and the housing 104, for example. Specifically, in order to clearly present the internal structure of the motion sensing device 100, the housing 102 is omitted in FIG. 1B.

In the present embodiment, the first light sensor 110 is configured to receive ambient light AL. The motion sensing device 100 receives the ambient light AL by using the first light sensor 110 so as to detect a movement of an object to generate a detection result. To be specific, the first light sensor 110 is an infrared (IR) sensor IFS capable of detecting the movement of the object through, for example, a pyroelectric effect. For instance, the IR sensor IFS may receive IR light irradiated by the object in the ambient light. When the object moves, the IR sensor IFS generates an electrical signal based on the detection of ambient temperature changes. In the present embodiment, the object may be, for example, an organism, such as a human body, a cat or a dog, but the invention is not limited thereto. For instance, when the organism enters a sensing range of the IR sensor IFS, a body temperature change of the organism causes intensity variation of the IR light, and thus, the IR sensor IFS may sense the movement of the organism.

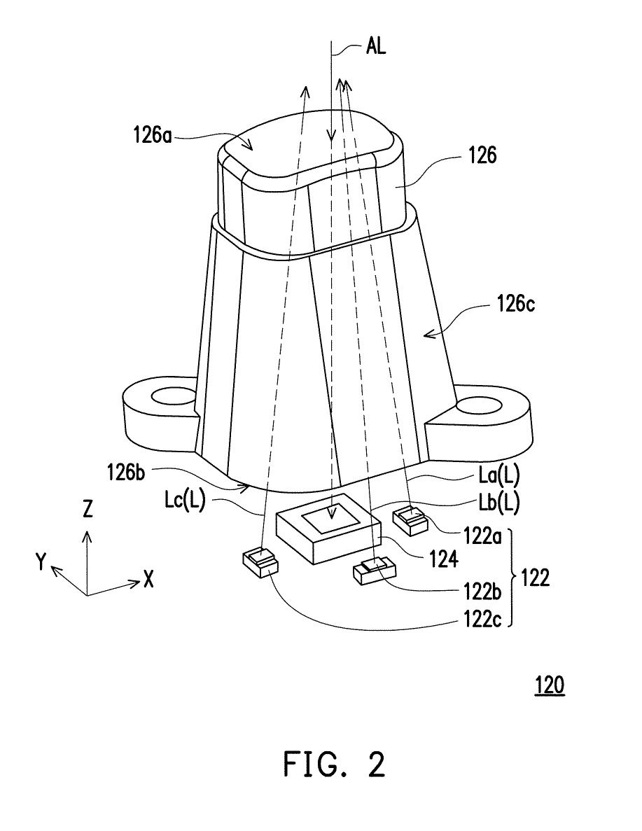

FIG. 2 is a schematic structure diagram illustrating the photoelectric module of the embodiment depicted in FIG. 1A, and FIG. 3 is a schematic diagram illustrating connection relation among a part of components of the motion sensing device of the embodiment depicted in FIG. 1A. Referring to both FIG. 1A and FIG. 3, in the present embodiment, the first light sensor 110 is configured to receive the ambient light AL and then generate a first electrical signal S1. The processor 130 is electrically connected with the first light sensor 110 and generates the detection result according to the first electrical signal S1. To be specific, in some embodiments, the motion sensing device 100 may be connected with, for example, an external network in a wired or wireless manner, or a speaker, an alarm, a display device or other devices to implement various applications according to the detection result, but the invention is not limited thereto.

Referring to both FIG. 2 and FIG. 3, in the present embodiment, the photoelectric module 120 includes a light source 122 and a second light sensor 124. To be specific, the photoelectric module 120 further includes a lens 126. The light source 122 is configured to emit light L, and the second light sensor 124 is disposed beside the light source 122 and configured to receive the ambient light AL. In addition, the light source 122 and the second light sensor 124 are disposed beside the lens 126. Specifically, the lens 126 has a light entry/exit surface 126a and a light entry/exit surface 126b opposite to the light entry/exit surface 126a. The light source 122 and the second light sensor 124 are disposed, for example, beside the light entry/exit surface 126b, and the light entry/exit surface 126a is located above the light source 122 and the second light sensor 124. Additionally, referring to both FIG. 1A and FIG. 2, the housing 102 has, for example, an opening O exposing the light entry/exit surface 126a of the lens 126 of the photoelectric module 120. The light entry/exit surface 126b may be, for example, concave in coordination with shapes of the light source 122 and the second light sensor 124 to form a containing space for containing at least a part of the light source 122 and the second light sensor 124 to prevent the lens 126 from interfering with the light source 122 and the second light sensor 124. However, in some embodiments, the light entry/exit surface 126b may also be designed as a plane or a surface approximate to a plane, and positions of the lens 126, the light source 122 and the second light sensor 124 may be fixed by other mechanism parts to prevent the lens 126 from interfering with the light source 122 and the second light sensor 124, but the invention is not limited thereto.

To be specific, the light L emitted by the light source 122 enters the lens 126 through the light entry/exit surface 126b, and the light L passing through the lens 126 exits from lens 126 through the light entry/exit surface 126a. Additionally, the ambient light AL enters the lens 126 through the light entry/exit surface 126a, and the ambient light AL passing through the lens 126 exits from the lens 126 through the light entry/exit surface 126b and is transmitted to the second light sensor 124. Namely, the light source 122 and the second light sensor 124 commonly share the lens 126. In the present embodiment, the light L is, for example, visible light emitted from the light source 122 and transmitted to an observer through the lens 126. Additionally, the ambient light AL passing through the lens 126 is transmitted to the second light sensor 124 through the lens 126. To be specific, a material of the lens 126 may be a light-transparent material, including but not limited to, transparent plastic (e.g., polycarbonate (PC), polymethylmethacrylate (PMMA) and so on), glass or a crystal material. In the present embodiment, the lens 126 further includes a side surface 126c connected with the light entry/exit surface 126a, and the side surface 126c surrounds the light entry/exit surface 126a. The side surface 126c is located, for example, between the light entry/exit surface 126a and the light entry/exit surface 126b, and the side surface 126c is connected with the light entry/exit surfaces 126a and 126b. During the process of the light L passing through the lens 126, at least a part of the light L is transmitted to the side surface 126c and reflected thereby. To be specific, the side surface 126c of the lens 126 of the present embodiment is processed by, for example, a polishing treatment, such that the light L transmitted to the side surface 126b is reflected with a relatively large proportion, and a relatively large proportion of the light L may be reflected back and forth in the lens 126 and transmitted to the light entry/exit surface 126a. Thus, the light L exiting from the lens 126 through the light entry/exit surface 126a has relatively high directivity.

In some embodiments, the side surface 126b may be disposed with a light-reflective material, for example, plated with a light-reflective film, and a material of the light-reflective film may be, for example, aluminum. In this way, the light L transmitted to the side surface 126c is mostly reflected, such that in these embodiments, the light L exiting from the lens 126 through the light entry/exit surface 126a has higher directivity. In addition, in some other embodiments, the photoelectric module 120 may also be not provided with the lens 126. In these embodiments, the opening O of the housing 102 directly exposes the light source 122 and the second light sensor 124. The light L emitted by the light source 122 passing through the opening O exits from the photoelectric module 120, and the ambient light AL passing through the opening O is transmitted to the second light sensor 124, but the invention is not limited thereto.

Additionally, referring to FIG. 1A, FIG. 1B and FIG. 2, specifically, in the present embodiment, the motion sensing device 100 is located in a space constructed by a first axis X, a second axis Y and a third axis Z which are perpendicular to one another. The second light sensor 124 and the light source 122 are located on, for example, a plane constructed by the first axis X and the second axis Y.

Referring to FIG. 2 and FIG. 3, in the present embodiment, the processor 130 is electrically connected with the light source 122 and configured to provide a driving signal Sd to the light source 122 according to the detection result, so as to drive the light source 122 to emit the light L. In detail, a sensing or operation state of the motion sensing device 100 may be obtained by the external through the light L. Specifically, an amount of the light source 122 is two or more, and these light sources 122 include light-emitting diode (LED) light sources in different colors. For instance, these light sources 122 include a light source 122a, a light source 122b and a light source 122c. The light source 122a includes a green-color LED configured to emit green-color light La, the light source 122b includes a red-color LED configured to emit red-color light Lb, and the light source 122c includes an orange-color LED configured to emit orange-color light Lc. Specifically, the green-color light La may be configured to, for example, indicate that the motion sensing device 100 is in a power-on or operable state, the red-color light Lb may be configured to, for example, indicate an abnormal or alarm state, and the orange-color light Lc may be configured to, for example, indicate that the movement of the object is detected. In the present embodiment, with the surface design of the lens 126, the light transmitted to the lens 126 may be adaptively refracted and/or reflected, such that optical paths of each light source 122 and the ambient light AL may meet requirements. Additionally, the motion sensing device 100 may also include the light sources 122 of other numbers or in other colors, which is no limited in the invention.

In the present embodiment, the processor 130 is electrically connected with the second light sensor 124. The processor 130 is configured to drive the second light sensor 124 to receive the ambient light AL to generate a second electrical signal S2. Additionally, the processor 130 adjusts the detection result according to the second electrical signal S2. Specifically, the processor 130 may further provide the driving signal Sd to the light source 122 according to the adjusted detection result, so as to drive the light source 122 to emit the light L. Thus, the first light sensor 110 and the second light sensor 124 may be configured to commonly detect the ambient light AL. The second light sensor 124 is, for example, a light sensor capable of receiving visible light and configured to compensate or correct a detection result obtained by the first light sensor 110 detecting the ambient light AL, such that the detection result of the motion sensing device 100 detecting the movement of the object may be more accurate. Additionally, by operating the first light sensor 110 capable of detecting the movement of the object based on the detection of ambient temperature changes in coordination with the second light sensor 124 capable of detecting the intensity of the ambient visible light, the motion sensing device 100 may perform operations that more satisfies the users' demands. For instance, when people's entry and/or exit is detected during the night time, the processor 130 may drive lighting or alert. When people's entry and/or exit is detected during the day time, the processor 130 may not necessarily drive the lighting or alert.

To be specific, the processor 130 may be, for example, hardware with computation capability (e.g., a chipset, a processing unit, and so on). For instance, the processor 130 may be a central processing unit (CPU), or any other programmable microprocessor, digital signal processor (DSP), programmable controller, application specific integrated circuit (ASIC), programmable logic device (PLD) or other similar devices, which is not limited in the invention.

FIG. 4 is a schematic diagram of the processor of the embodiment depicted in FIG. 1A driving the light source 122 and the second light sensor 124 in timing sequence. Referring to FIG. 4 and FIG. 2, in the present embodiment, the processor 130 drives the light source 122, such that the light source 122 emits the light L in a plurality of emitting periods T1 and does not emit light in a plurality of non-emitting periods T2. Additionally, the emitting periods T1 and the non-emitting periods T2 are, for example, alternately arranged in timing sequence. Specifically, the non-emitting periods T2 include at least one sampling period Ts, and the processor 130 drives the second light sensor 124 to receive the ambient light AL in the at least one sampling period Ts. In the present embodiment, the number of the sampling periods Ts is, for example, plural, and each non-emitting period T2 includes a sampling period Ts. However, in some embodiments, the number of the sampling period Ts may not have to correspond to the number of the non-emitting periods T2. Or, alternatively, the number of the sampling periods Ts may be one. In some other embodiments, some non-emitting periods T2 may not include any sampling period Ts, or one non-emitting period T2 may include a plurality of sampling period Ts, but the invention is not limited thereto.

In the present embodiment, these emitting periods T1 and the at least one sampling period Ts do not overlap in timing sequence (referring to the emitting periods T1 and the multiple sampling period Ts on a timeline in FIG. 4). In other words, when the light source 122 emits the light L, the second light sensor 124 does not receive the ambient light AL. To be specific, each emitting period T1 may fall, for example, within a range from 0.5 seconds to 1 second, and each non-emitting period T2 may fall, for example, within a range from 10 millisecond (ms) to 12 ms, which may be 10 ms, for example. In the present embodiment, a duration of persistence of human eyes' vision approximately falls within a range from 60 ms to 100 ms, which is obviously more than a duration of one non-emitting period T2. Thus, when the emitting periods T1 and the non-emitting periods T2 are alternated in timing sequence, the observer is not aware of the non-emitting periods T2. By contrast, the observer is aware that these light sources 122 continuously emit the light L, while the light L does not flash. However, in other embodiments, each emitting period T1 and each non-emitting period T2 may also fall within other time ranges, which are not limited in the invention. For instance, each emitting period T1 may be arbitrarily set to another time range, and each non-emitting period T2 may also be designed to be equal to or more than the duration of persistence of human eyes' vision, thereby causing the observer to see the flashing light L, but the invention is not limited thereto. Additionally, according to actual lighting demands, the light L emitted by the light source 122 may be driven as continuous light (without flashing) or flashing light in an emitting period T1, but the invention is not limited thereto.

In the present embodiment, each non-emitting period T2 includes a sampling period Ts, and each sampling period Ts is not over a non-emitting period T2. Thus, the sampling periods Ts do not overlap the emitting periods T1 in timing sequence, such that the second light sensor 124 does not receive the ambient light AL while these light sources 122 emit the light L.

In the present embodiment, a white astigmatism agent in an adaptive amount may be doped in the lens 126, such that lighting uniformity of the light L emitted from the lens 126 may meet actual demands. Additionally, a dynamic range of the second light sensor 124 with respect to light sensing in linear response falls within a range from 0.01 lux to 157 klux. Thus, even though transparency of the lens 126 is reduced due to the adjustment of the lighting uniformity of the light L, the dynamic range of the second light sensor 124 with respect to light sensing is still wide. Thus, the second light sensor 124, being adjusted by adaptive hardware or software, still may receive and sense the ambient light AL, such that both the lighting and light sensing demands of the motion sensing device 100 may be satisfied.

To be specific, in the present embodiment, the motion sensing device 100 includes the photoelectric module 120, and the processor 130 is configured to drive the light source 122 to emit the light L according to the detection result, drive the light sensor (e.g., the second light sensor 124) to receive the ambient light AL to generate the corresponding electrical signal (e.g., the second electrical signal S2) and adjust the detection result according to the electrical signal. Additionally, when the light source 122 emits the light L, the light sensor does not receive the ambient light. Thus, the light source 122 and the light sensor may be driven in a time sharing manner to avoid optical interference. As the time on switching the light source 122 between to light or not to light (i.e., turn off the light source 122) is fast enough, and each non-emitting period T2 is set to be less than the duration of persistence of human eyes' vision, the observer is not aware of the light source 122 being turned off. In the present embodiment, the light source 122 and the light sensor may be designed to share the same lens 126 for transmitting the light L and transmitting the ambient light AL, such that the motion sensing device 100 of the present embodiment does not have to be disposed with a plurality of lenses respectively configured for transmitting the light L emitted by these light sources 122 and transmitting the ambient light AL. Thereby, the number of lenses as used is reduced, and the motion sensing device 100 may have a smaller volume. In addition, an area of a printed circuit board (PCB) disposed in the photoelectric module 120 may be designed to be smaller, such that the motion sensing device 100 has simplified assembly components, less material cost and less assembly cost. Additionally, as the number of lenses as used is reduced, the holes on the housing (e.g., the housing 102 or 104 of the motion sensing device 100) which are made in coordination with the lenses may be reduced, and thus, the appearance design of the motion sensing device 100 may be more compact.

FIG. 5 is a flowchart illustrating a driving method of a motion sensing device according to an embodiment of the invention. Referring to FIG. 5, in the present embodiment, the driving method may be at least applied to the motion sensing device 100 of the embodiments depicted in FIG. 1A and FIG. 1B. The driving method of the motion sensing device includes the following steps. In step S510, a first light sensor is driven to receive ambient light to generate a first electrical signal and to generate a detection result according to the first electrical signal. In step S520, at least one light source is driven to emit at least one light according to the detection result. Additionally, in step S530, a second light sensor is driven to receive the ambient light to generate a second electrical signal and to adjust a detection result according to the second electrical signal. When the at least one light source emits the at least one light, the second light sensor does not receive the ambient light. To be specific, teaching, suggestion and implementation with respect to the driving method of the motion sensing device of the embodiment of the invention may be sufficiently obtained according to the descriptions related to the embodiments depicted in FIG. 1A to FIG. 4 and thus, will not be repeated.

Based on the above, in the motion sensing device, the photoelectric module and the driving method of the motion sensing device provided according to the embodiments of the invention, the processor is configured to drive the light source to emit the light according to the detection result, drive the light sensor (i.e., the second light sensor) to receive the ambient light to generate the corresponding electrical signal (i.e., the second electrical signal) and adjust the detection result according to the electrical signal. In addition, when the light source emits the light, the light sensor does not receive the ambient light. Thus, the light source and the light sensor can be driven in a time sharing manner to avoid optical interference. The light source and the light sensor can be designed to share the same lens for light transmission, such that the motion sensing device, with the use of the reduced number of lenses, can have a smaller volume, less material cost and less assembly cost. Moreover, the motion sensing device having simplified assembly components can contribute to compactness of the appearance design.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A motion sensing device, configured to detect a movement of an object to generate a detection result, the motion sensing device comprising:
a first light sensor, configured to receive ambient light to generate a first electrical signal;
a photoelectric module, comprising:
at least one light source; and
a second light sensor, disposed beside the at least one light source; and
a processor, electrically connected with the first light sensor, the at least one light source and the second light sensor and configured to generate the detection result according to the first electrical signal, wherein the processor is configured to drive the at least one light source to emit at least one light according to the detection result, drive the second light sensor to receive the ambient light to generate a second electrical signal and adjust the detection result according to the second electrical signal, wherein the second light sensor does not receive the ambient light when the at least one light source emits the at least one light.

2. The motion sensing device according to claim 1, wherein the processor drives the at least one light source to emit the at least one light in a plurality of emitting periods and not to emit light in a plurality of non-emitting periods, wherein the emitting periods and the non-emitting periods are alternately arranged in timing sequence.

3. The motion sensing device according to claim 2, wherein the non-emitting periods comprises at least one sampling period, and the processor drives the second light sensor to receive the ambient light in the at least one sampling period.

4. The motion sensing device according to claim 2, wherein each of the emitting periods falls within a range from 0.5 seconds to 1 second, and each of the non-emitting periods within a range from 10 millisecond (ms) to 12 ms.

5. The motion sensing device according to claim 1, wherein the photoelectric module further comprises a lens, the at least one light source and the second light sensor are disposed beside the lens, and the lens has a light entry/exit surface, wherein the at least one light emitted from the at least one light source passing through the lens exits from the lens through the light entry/exit surface, the ambient light enters the lens through the light entry/exit surface, and the ambient light passing through the lens is transmitted to the second light sensor.

6. The motion sensing device according to claim 1, wherein an amount of the at least one light source is two or more, and the light sources comprise light-emitting diode (LED) light sources in difference colors.

7. The motion sensing device according to claim 1, wherein the first light sensor is an infrared (IR) sensor.

8. A photoelectric module, adapted to be disposed in a motion sensing device, wherein the motion sensing device is configured to detect a movement of an object to generate a detection result and has a processor configured to adjust the detection result, the photoelectric module comprising:
at least one light source; and
a light sensor, disposed beside the at least one light source, wherein the processor is electrically connected with the at least one light source and the light sensor, the processor is configured to drive the least one light source to emit at least one light according to the detection result, drive the light sensor to receive ambient light to generate an electrical signal and adjust the detection result according to the electrical signal, wherein the light sensor does not receive the ambient light when the at least one light source emits the at least one light.

9. The photoelectric module according to claim 8, wherein the processor drives the at least one light source to emit the at least one light in a plurality of emitting periods and not to emit light in a plurality of non-emitting periods, wherein the emitting periods and the non-emitting periods are alternately arranged in timing sequence.

10. The photoelectric module according to claim 9, wherein the non-emitting periods comprises at least one sampling period, and the processor drives the light sensor to receive the ambient light in the at least one sampling period.

11. The photoelectric module according to claim 8, further comprising a lens, wherein the at least one light source and the light sensor are disposed beside the lens, and the lens has a light entry/exit surface, wherein the at least one light emitted from the at least one light source passing through the lens exits from the lens through the light entry/exit surface, the ambient light enters the lens through the light entry/exit surface, and the ambient light passing through the lens is transmitted to the light sensor.

12. A driving method of a motion sensing device configured to detect a movement of an object to generate a detection result, the driving method comprising:
driving a first light sensor to receive ambient light to generate a first electrical signal and to generate the detection result according to the first electrical signal;
driving the at least one light source to emit at least one light according to the detection result; and
driving a second light sensor to receive the ambient light to generate a second electrical signal and to adjust the detection result according to the second electrical signal, wherein the second light sensor does not receive the ambient light when the at least one light source emits the at least one light.

13. The driving method according to claim 12, wherein the step of driving the at least one light source to emit the at least one light according to the detection result further comprises:
driving the at least one light source to emit the at least one light in a plurality of emitting periods and not to emit light in a plurality of non-emitting periods, wherein the emitting periods and the non-emitting periods are alternately arranged in timing sequence.

14. The driving method according to claim 13, wherein the non-emitting periods comprise at least one sampling period, and the step of driving the second light sensor to receive the ambient light further comprises:
driving the second light sensor to receive the ambient light in the at least one sampling period.

15. The driving method according to claim 13, wherein each of the emitting periods falls within a range from 0.5 seconds to 1 second, and each of the non-emitting periods within a range from 10 millisecond (ms) to 12 ms.
